(19) United States
(12) Patent Application Publication
(10) Pub. No.: US 2011/0125891 A1
(43) Pub. Date: May 26, 2011

(54) REMOTE MANAGEMENT APPARATUS AND REMOTE MANAGEMENT SYSTEM

(75) Inventor: Seiji Kawai, Shiga (JP)

(73) Assignee: DAIKIN INDUSTRIES, LTD., Osaka-shi, Osaka (JP)

(21) Appl. No.: 13/055,523

(22) PCT Filed: Jul. 23, 2009
(86) PCT No.: PCT/JP2009/063145

§ 371 Date: Jan. 24, 2011

(30) Foreign Application Priority Data
Jul. 29, 2008 (JP) 2008-194928

(51) Int. Cl. G06F 15/173

(52) U.S. Cl. 709/223

(57) ABSTRACT

A remote management apparatus remotely manages at least one facility device. The remote management apparatus includes a provisional registration unit and a main registration unit. The provisional registration unit registers a device identifier, which is transmitted from and identifies the facility device. The main registration unit registers user information, which is transmitted from a registration terminal and is related to a user of the facility device, such that the user information is associated with the device identifier. A remote management system includes the facility device, the remote management apparatus and a registration terminal. The registration terminal is connected to the remote management apparatus when the facility device is being registered in the remote management apparatus. In the remote management system, the facility device includes a notification unit, which reports a device identifier that identifies the facility device to the remote management apparatus.

### TECHNICAL FIELD

The present invention relates to a remote management apparatus configured to remotely manage at least one facility device, and a remote management system provided with the same.

### BACKGROUND ART

In the conventional art, a remote management service is known that uses a remote management apparatus to remotely manage devices, such as air conditioners, in a facility. To implement such a service, it is necessary to preregister at least a device identifier for each facility device and user information related to the user of each facility device, such that they are mutually associated in the remote management apparatus (e.g., Japanese Unexamined Patent Application Publication No. 2005-301982 of Patent Document 1). Furthermore, such an initial setting is manually implemented by a serviceperson and the like, who logs into the remote management apparatus.

### SUMMARY OF THE INVENTION

### <Technical Problem>

Incidentally, confusion generally attends the inputting of a device identifier. This is because a device identifier is often a character string with which one cannot instinctually identify the corresponding air conditioner. Nevertheless, if there is an error in initialization, then the remote management service will not function normally.

An object of the present invention is to make it easy to perform an operation of registering a facility device and its user in a remote management apparatus such that they are associated with one another.

### <Solution to Problem>

A remote management apparatus according to a first aspect of the present invention comprises a provisional registration unit and a main registration unit and is configured to remotely manage at least one facility device. The provisional registration unit is configured to register a device identifier, which is transmitted from the facility device. The device identifier is information that identifies the facility device. The main registration unit is configured to register user information, which is transmitted from a registration terminal, such that the user information is associated with the device identifier. The user information is information related to a user of the facility device.

The present remote management apparatus accepts the provisional registration of the device identifier transmitted from the facility device prior to a main registration. Thereby, it becomes easy to associate the device identifier with the user information, namely, to perform the main registration that associates the facility device and the user with one another.

A remote management apparatus according to a second aspect of the present invention is the remote management apparatus according to the first aspect of the present invention, wherein the main registration unit is configured to reference suggesting information, which is further transmitted from the registration terminal, to associate the user information with the device identifier. The suggesting information is information that suggests the facility device. The present remote management apparatus receives from the registration terminal the user information together with the suggesting information. Thereby, the facility device suggested by the suggesting information and the user related to the user information can be associated with one another.

A remote management apparatus according to a third aspect of the present invention is the remote management apparatus according to the second aspect of the present invention, wherein the suggesting information is terminal LAN information. The terminal LAN information is information that identifies a LAN wherein the registration terminal is present. The provisional registration unit is configured to further register device LAN information such that the device LAN information is associated with the device identifier. The device LAN information is information that identifies a LAN wherein the facility device is present.

The main registration unit is configured to further reference the device LAN information to associate the user information with the device identifiers.

The present remote management apparatus receives the device identifier together with the device LAN information from the facility device during the provisional registration. In addition, it receives the user information together with the terminal LAN information, which serves as the suggesting information, from the registration terminal during the main registration. Thereby, the user information transmitted from the registration terminal can be associated with the facility device that is present in the same LAN as that of the registration terminal.

A remote management apparatus according to a fourth aspect of the present invention is the remote management apparatus according to the second aspect of the present invention, wherein the main registration unit is configured to request an operator of the registration terminal to input the suggesting information via the registration terminal.

The present remote management apparatus receives the suggesting information from the operator of the registration terminal during the main registration. Thereby, the operator of the registration terminal can specify the facility device to be registered.

A remote management apparatus according to a fifth aspect of the present invention is the remote management apparatus according to the fourth aspect of the present invention, wherein the suggesting information is the device identifier.

The present remote management apparatus, during the main registration, requests the operator of the registration terminal to input the device identifier of the facility device to be registered, and receives the device identifier. Thereby, the operator of the registration terminal can specify the facility device to be registered using the device identifier.

A remote management apparatus according a sixth aspect of the present invention is the remote management apparatus according to the fourth aspect of the present invention, wherein the suggesting information is a keyword, which is set for the facility device. The provisional registration unit is configured to further register the keyword, which is further transmitted from the facility device, such that the keyword is associated with the device identifier.

The present remote management apparatus, during the main registration, requests the operator of the registration terminal to input a keyword, which is set for the facility device to be registered, and receives this keyword. Thereby, the operator of the registration terminal can specify the facility device to be registered using the keyword.

A remote management apparatus according to a seventh aspect of the present invention is the remote management apparatus according to the fourth aspect of the present invention, and further comprises an authentication unit. The authentication unit is configured to authenticate the registration terminal. The authentication unit is configured to request the user information from the registration terminal in order to perform the authentication. The main registration unit is configured to associate the user information acquired by the authentication unit with the device identifier.

The present remote management apparatus, during the main registration, authenticates the registration terminal using the user information and associates the user information for the authentication with the device identifier. Accordingly, the facility device and the user can be easily associated without requesting the operator of the registration terminal to input his or her user information.

A remote management system according to an eighth aspect of the present invention comprises at least one facility device, a remote management apparatus, and a registration terminal. The remote management apparatus is configured to remotely manage the facility device. The registration terminal is configured to be connected to the remote management apparatus when the facility device is being registered in the remote management apparatus. The facility device includes a notification unit. The notification unit is configured to report the device identifier to the remote management apparatus. The device identifier is information that identifies the facility device. The remote management apparatus includes a provisional registration unit and a main registration unit. The provisional registration unit is configured to register the device identifier reported from the notification unit. The main registration unit is configured to register the user information, which is transmitted from the registration terminal, such that the user information is associated with the device identifier. The user information is information that is related to a user of the facility device.

In the present remote management system, the remote management apparatus accepts the provisional registration of the device identifier transmitted from the facility device prior to the main registration. Thereby, it becomes easy to associate the device identifier and the user information, namely, it becomes easy to perform the main registration, which associates the facility device with the user.

A remote management system according to a ninth aspect of the present invention is the remote management system according to the eighth aspect of the present invention, wherein the main registration unit is configured to reference the suggesting information, which is further transmitted from the registration terminal, to associate the user information with the device identifier. The suggesting information is information that suggests the facility device.

In the present remote management system, the remote management apparatus receives from the registration terminal the user information together with the suggesting information. Thereby, the facility device suggested by the suggesting information and the user related to the user information can be associated with one another.

A remote management system according to a tenth aspect of the present invention is the remote management system according to the eighth or ninth aspect of the present invention, wherein the notification unit is configured to automatically report the device identifier to the remote management apparatus when the power supply to the facility device is turned on or when the facility device is connected to a LAN.

In the remote management system, when the power supply to the facility device is turned on or when the facility device is connected to the LAN, the facility device automatically reports its device identifier to the remote management apparatus. Thereby, the provisional registration that registers the device identifier in the remote management apparatus can be performed easily.

### <Advantageous Effects of Invention>

According to the present invention, a provisional registration of a device identifier is performed prior to a main registration, which associates the device identifier with user information. Thereby, the operation of registering a facility device and its user in a remote management apparatus such that they are associated with one another becomes easy.

### BRIEF DESCRIPTION OF THE DRAWINGS

FIG. 1 is a block diagram of a remote management system according to one embodiment of the present invention.

FIG. 2 is a block diagram of an air conditioner.

FIG. 3 is a block diagram of an initialization personal computer.

FIG. 4 is a block diagram of a mobile phone.

FIG. 5 is a block diagram of a remote management server.

FIG. 6 shows the data structure of a user database.

FIG. 7 shows the data structure of a provisional registration database.

FIG. 8 shows the data structure of a basic information database.

FIG. 9 shows the flow of a main registration of the air conditioner, which is performed on the remote management server.

FIG. 10 shows a main registration screen.

### DESCRIPTION OF EMBODIMENTS

The following text explains a remote management system 1 of air conditioners 50a, 50b, . . . according to one embodiment of the present invention, referencing the drawings.

### <Overall Configuration>

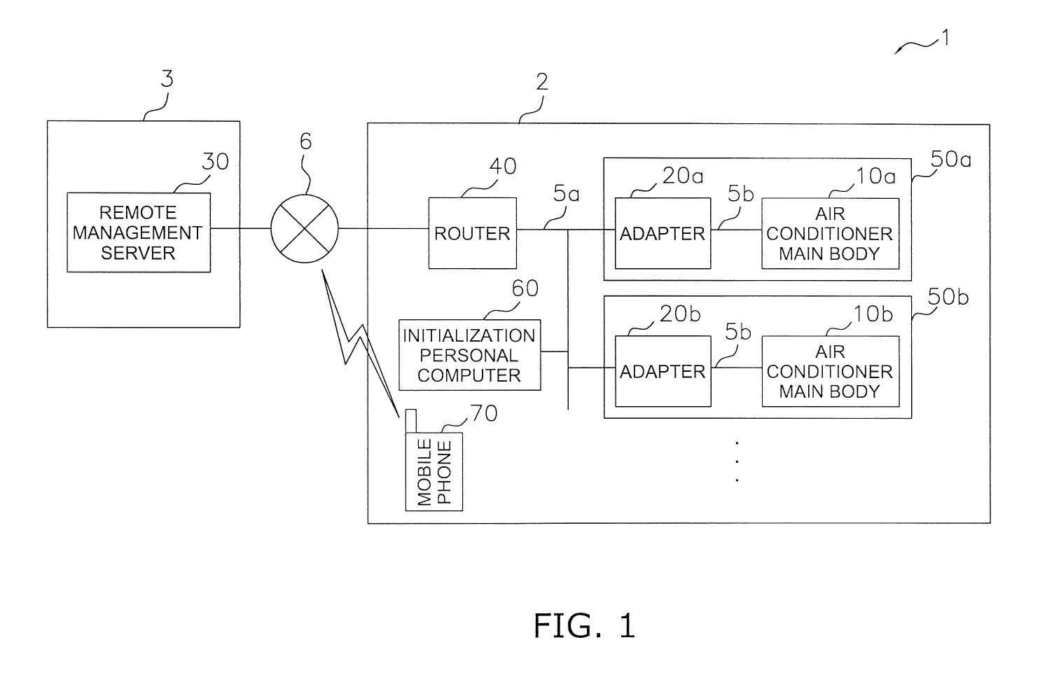

FIG. 1 shows the configuration of the entire remote management system 1. The remote management system 1 monitors and controls the plurality of air conditioners 50a, 50b, . . . , which are disposed in a property (a building or buildings) 2, from a remote management server 30, which is disposed in a remote management center 3. The air conditioners 50a, 50b, . . . and the remote management server 30 are connected via an Internet 6.

A router 40 is installed in the property 2 and connects the Internet 6 and a local area network 5a (hereinbelow, called a “LAN”), which is also installed inside the property 2. In addition to the air conditioners 50a, 50b, . . . , network devices such as personal computers and printers (not shown) used inside the property 2 are also connected to the LAN 5a.

In order for the remote management server 30 to start monitoring and controlling the air conditioners 50a, 50b, . . . , the air conditioners 50a, 50b, . . . must first be preregistered in the remote management server 30. An initialization personal computer 60 and a mobile phone 70 shown in FIG. 1 are devices used by a serviceperson during such initialization.

Furthermore, for the sake of simplicity, only one property, namely, the property 2, is shown in the FIG. 1; however, it is understood that the air conditioners 50a, 50b, . . . of the remote management system 1 are dispersed in a plurality of the properties 2.

<Air conditioner>

As shown in FIG. 1, the air conditioners 50a, 50b, . . . comprise air conditioner main bodies 10a, 10b, . . . and adapters 20a, 20b, . . . , which are for the purpose of connecting the air conditioner main bodies 10a, 10b, . . . , respectively, to the LAN 5a. The air conditioner main bodies 10a, 10b, . . . and the adapters 20a, 20b, . . . are connected with a one-to-one correspondence.

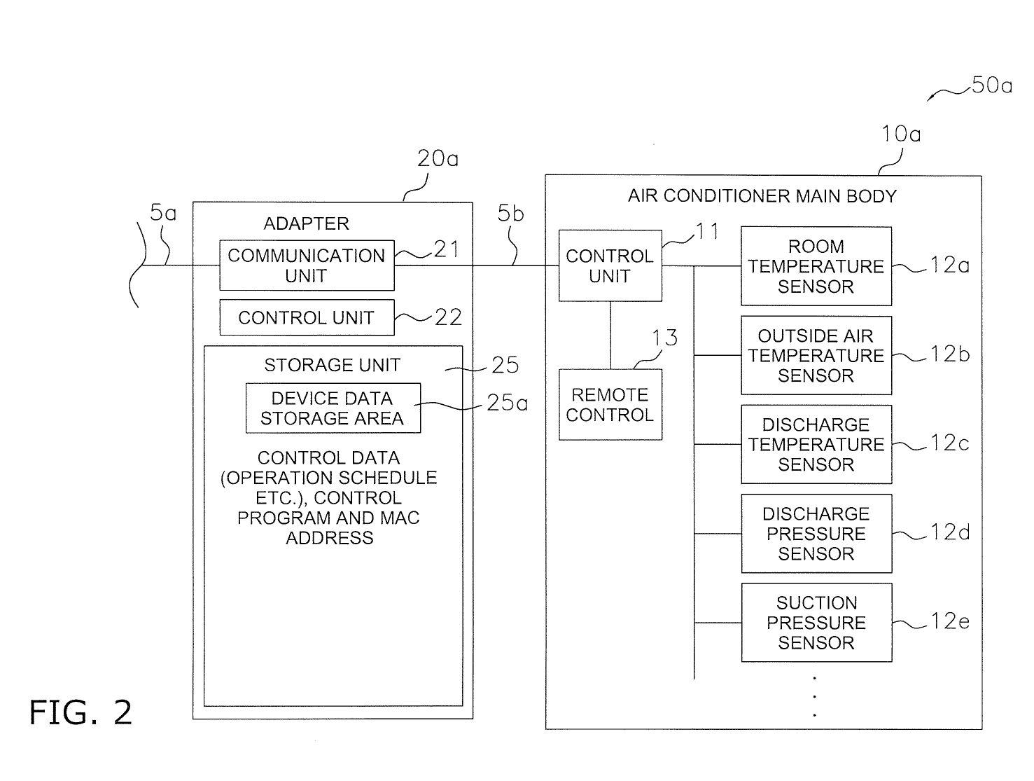

The following text explains the configuration of the air conditioner 50a, referencing FIG. 2; however, it is understood that the other air conditioners 50b, . . . each have an identical configuration to that of the air conditioner 50a.

a) Air Conditioner Main Body

The air conditioner main body 10a comprises an outdoor unit and one or a plurality of indoor units connected to the outdoor unit via a refrigerant piping, all of which are not shown; furthermore, a refrigerant circuit (not shown) is formed that comprises a compressor, a heat exchanger, and the like. The adapter 20a is mounted at a prescribed position inside the casing of the host indoor unit.

As shown in FIG. 2, various sensors 12a, 12b, 12c, 12d, 12e, . . . are mounted in the air conditioner main body 10a. The sensor 12a detects the temperature of the room wherein the indoor unit is installed. The sensor 12b detects the temperature of the outside air in the vicinity of the property 2. The sensor 12c detects the temperature of refrigerant in a discharge tube of the compressor (not shown). The sensor 12d detects the pressure of the refrigerant in the discharge tube of the compressor (not shown). The sensor 12e detects the pressure of the refrigerant in a suction tube of the compressor (not shown).

In addition, the air conditioner main body 10a comprises a control unit 11. The control unit 11 is a collection of controllers of the indoor unit and the outdoor unit included in the air conditioner main body 10a.

The control unit 11 controls the operation of the air conditioner main body 10a in accordance with an operation instruction sent to the indoor unit, wherein the operation instruction is input by an general user (end user) inside the property 2 via a remote control 13; namely, the control unit 11 controls the operation of controlled parts, such as the compressor, included in the refrigerant circuit.

In addition, the control unit 11 transmits to the adapter 20a device data related to the air conditioner main body 10a. For example, the control unit 11 transmits detection values (i.e., device data) of the various sensors 12a, 12b, 12c, 12d, 12e, . . . to the adapter 20a at prescribed intervals (in the present embodiment, in one minute intervals), and transmits data (i.e., device data) that indicates the content of the operation instruction input via the remote control 13 into the indoor unit. The data that indicates the content of the operation instruction is, for example, turn the power supply ON or OFF, set an operation mode (i.e., cooling mode, heating mode, ventilation mode, or the like), and set a temperature.

In addition, the control unit 11 executes the control command transmitted from the adapter 20a. The control command transmitted from the adapter 20a is, for example, an operation instruction to the indoor unit or a command to transmit specific device data to the adapter 20a.

b) Adapter

The adapter 20a is a network adapter for the purpose of connecting the air conditioner main body 10a to the LAN 5a. Furthermore, internal communication among the controlled parts included in the air conditioner main body 10a is conducted via a dedicated network 5b.

As shown in FIG. 2, the adapter 20a comprises a communication unit 21, a control unit 22, and a storage unit 25, as well as a communications function, which manages differences in communication protocols among the networks 5a, 5b, and a control function, which controls the air conditioner main body 10a.

The storage unit 25 stores a control program and control data. The control program and the control data can be updated by the remote management server 30 via the Internet 6. The control unit 22 performs, for example, the operation below by executing the control program while referencing the control data.

The control unit 22 transmits the control command to air conditioner main body 10a. For example, if an operation schedule (i.e., the control data) to start the air conditioner main body 10a every morning at 0900 hrs and to stop the air conditioner main body 10a every evening at 2100 hrs is registered in the storage unit 25, then the control unit 22 transmits a start up the air conditioner main body 10a command to the control unit 11 of the air conditioner main body 10a every morning at 0900 hrs, and transmits stop the air conditioner main body 10a command to the control unit 11 of the air conditioner main body 10a every evening at 2100 hrs.

In addition, a device data storage area 25a is reserved in the storage unit 25. The device data storage area 25a is for temporarily saving the device data transmitted from the air conditioner main body 10a. The control unit 22 converts the device data in the device data storage area 25a to a prescribed format at prescribed intervals (e.g., once a day), and transmits such to the remote management server 30 as periodic notification data.

In addition, the control unit 22 detects any abnormal conditions in the air conditioner main body 10a. Namely, based on the device data of the device data storage area 25a, the control unit 22 determines at prescribed intervals (in the present embodiment, at five minute intervals) whether there is an abnormal condition in the air conditioner main body 10a. Furthermore, if an abnormal condition is actually detected, then abnormal condition notification data to that effect is prepared and promptly transmitted to the remote management server 30.

In addition, the control unit 22 performs the provisional registration of the air conditioner 50a, which is discussed below.

In addition, a MAC address is stored in the storage unit 25. The MAC address is information that uniquely identifies the adapter 20a on the LAN 5a and the Internet 6.

### <Router>

The router 40 allocates IP addresses to the network devices (including the adapters 20a, 20b, . . . ) connected to the router 40. When the adapters 20a, 20b, . . . are connected to the LAN 5a, the router 40 automatically detects the presence of the adapters 20a, 20b, . . . and registers their network setting information (i.e., their MAC addresses, IP addresses, subnet masks, and the like). Thereby, the adapters 20a, 20b, . . . become capable of communicating with the other network devices in the LAN 5a as well as with network devices on the Internet 6.

In addition, the router 40 has a firewall function that, as a rule, blocks access to devices in the LAN 5a from a WAN (i.e., the Internet 6).

### <Initialization Personal Computer>

The initialization personal computer 60 is a device that serves in the initialization of the air conditioners 50a, 50b, . . . , which is performed by a serviceperson dispatched from the provider of the remote management service. The initialization personal computer 60 is carried to the property 2 by the serviceperson and, in principle, is connected to the LAN 5a only during the initialization of the air conditioners 50a, 50b, . . .

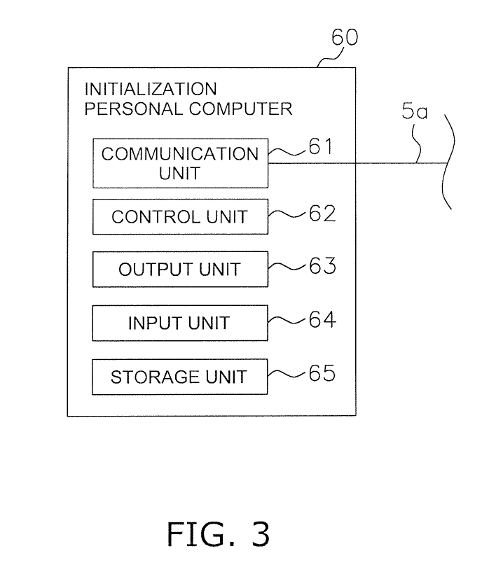

As shown in FIG. 3, the initialization personal computer 60 comprises a communication unit 61, a control unit 62, an output unit 63, an input unit 64, and a storage unit 65. The communication unit 61 makes it possible for the initialization personal computer 60 to connect to the LAN 5a. The control unit 62 comprises a CPU, RAM, ROM, and the like, and the storage unit 65 comprises an HDD and the like. The output unit 63 comprises a display, a speaker, and the like, and the input unit 64 comprises a mouse, a keyboard, and the like.

A Web browser is installed on the initialization personal computer 60. The serviceperson initializes the air conditioners 50a, 50b, . . . via a screen, which is provided on the Web browser by the remote management server 30 via the Internet 6.

### <Mobile Phone>

Like the initialization personal computer 60, the mobile phone 70 is a device that serves in the initialization of the air conditioners 50a, 50b, . . . , which is performed by a serviceperson dispatched from the provider of the remote management service. The serviceperson carries the mobile phone 70, rather than the initialization personal computer 60, to the property 2. Accordingly, although both the initialization personal computer 60 and the mobile phone 70 are shown in FIG. 1, it is sufficient for the serviceperson to carry only one of them.

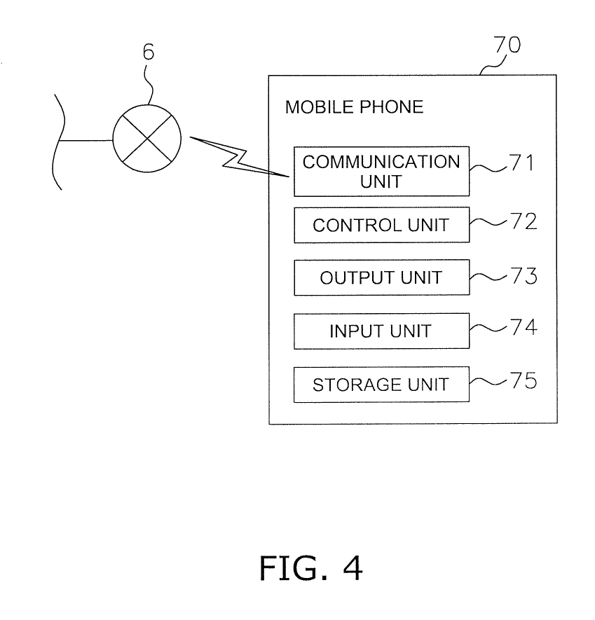

As shown in FIG. 4, the mobile phone 70 comprises a communication unit 71, a control unit 72, an output unit 73, an input unit 74, and a storage unit 75. The communication unit 71 comprises a calling function as well as a connection function, which is for connecting to the Internet 6. The control unit 72 comprises a CPU, RAM, ROM, and the like, and the storage unit 75 comprises flash memory and the like. The output unit 73 comprises a display, a speaker, and the like, and the input unit 74 comprises an operation button group and the like.

A mobile phone Web browser is installed in the mobile phone 70. The serviceperson initializes the air conditioners 50a, 50b, . . . via a screen, which is provided on the Web browser by the remote management server 30 via the Internet 6.

### <Remote Management Server>

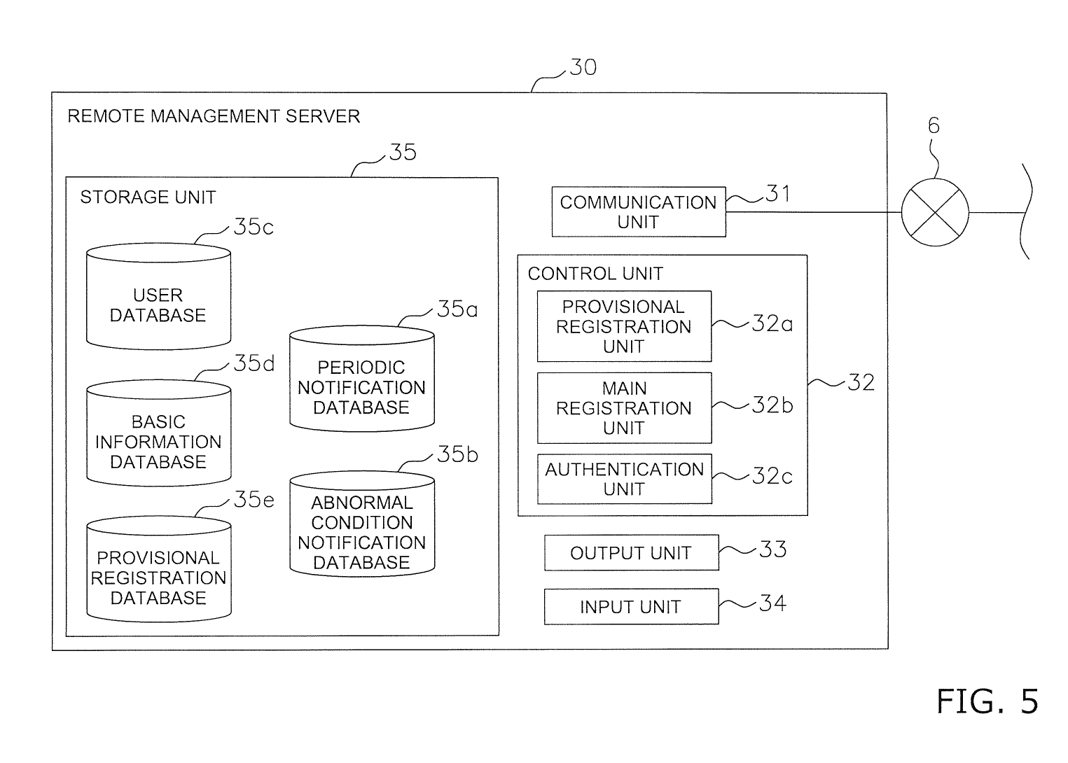

As shown in FIG. 5, the remote management server 30 comprises a communication unit 31, a control unit 32, an output unit 33, an input unit 34, and a storage unit 35.

The communication unit 31 handles the communications function of the remote management server 30 and connects the remote management server 30 to the Internet 6, namely, the communication unit 31 enables communication with the air conditioners 50a, 50b, . . . , the initialization personal computer 60, and the mobile phone 70.

Various databases, which are for accumulating various data related to the air conditioners 50a, 50b, . . . , are defined in the storage unit 35.

For example, a periodic notification database 35a, which accumulates periodic notification data transmitted from the air conditioners 50a. 50b, . . . to the remote management server 30 via the Internet 6, and an abnormal condition notification database 35b, which accumulates abnormal condition notification data, are defined in the storage unit 35. Furthermore, the databases 35a, 35b store aspects that associate the various data related to the air conditioners 50a, 50b, . . . with the MAC addresses of the air conditioners 50a, 50b, . . . .

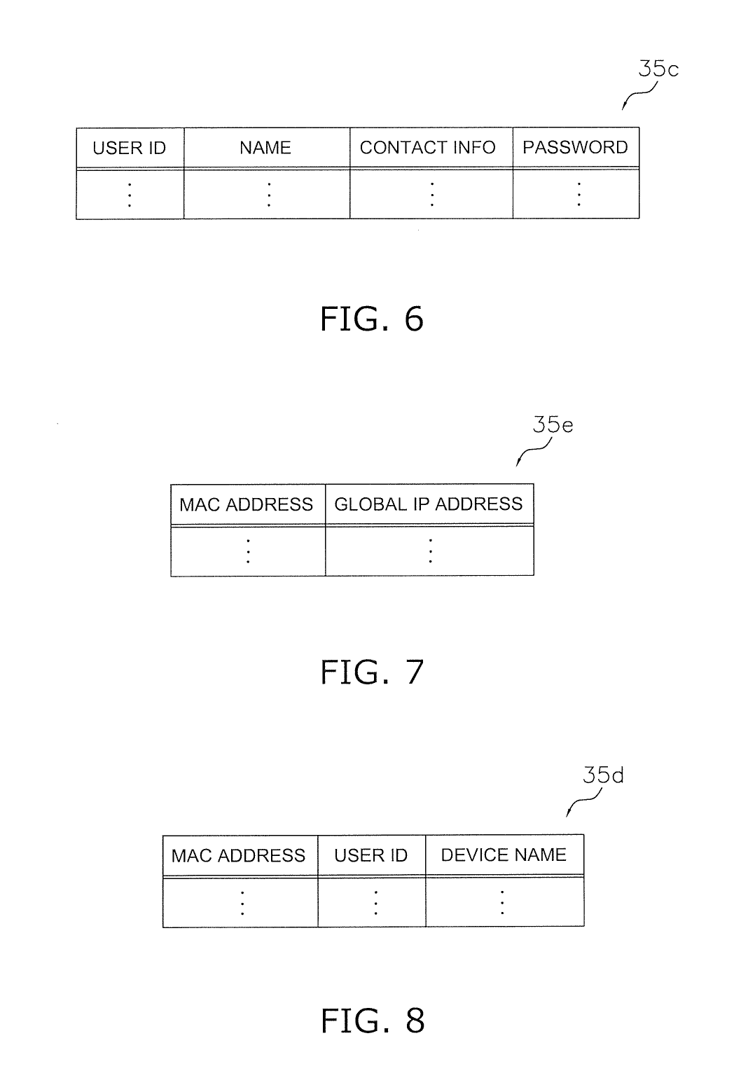

In addition, a tabular user database 35c (refer to FIG. 6), which stores information related to the users of the air conditioners 50a, 50b, . . . , is defined in the storage unit 35. The user database 35c stores a user ID, one of which is allocated to each user of the air conditioners 50a, 50b, . . . as well as the user's name, contact info (including the name and address of the property 2), password, and the like, as one record. The password is for authenticating login rights when a user logs into the remote management server 30 with a user ID. The records in the user database 35c have a one-to-one correspondence with the users.

Furthermore, a tabular basic information database 35d (refer to FIG. 8), which stores basic registration information (hereinbelow, called “basic information”) related to the air conditioners 50a, 50b, . . . , is also defined in the storage unit 35. The basic information database 35d stores as one record each combination of the MAC address of one of the air conditioners 50a, 50b, . . . , the corresponding user ID, and the corresponding device name. The records in the basic information database 35d have a one-to-one correspondence with the air conditioners 50a, 50b, . . . .

In addition, a tabular provisional registration database 35e (refer to FIG. 7), which stores provisional registration data of the air conditioners 50a, 50b, . . . , is also defined in the storage unit 35. The MAC address and the global IP address of each of the air conditioners 50a, 50b, . . . are stored as one record in the provisional registration database 35e. The records in the provisional registration database 35e have a one-to-one correspondence with the air conditioners 50a, 50b, . . . .

The control unit 32 comprises a CPU, RAM, ROM, and the like, and executes a control program stored in the storage unit 35. As a result, the control unit 32 operates as a provisional registration unit 32a, a main registration unit 32b, and an authentication unit 32c. The details of the operation of the provisional registration unit 32a, the main registration unit 32b, and the authentication unit 32c are discussed later. In addition, the control unit 32 tests for any abnormal conditions in the air conditioners 50a, 50b, . . . based on the various data stored in the databases 35a-35e, prepares, for the user, written reports and written proposals related to how the air conditioners 50a, 50b, . . . , are used by the user and the like. In addition, the control unit 32 is also capable of transmitting control commands to the air conditioners 50a, 50b, . . . via the Internet 6. Furthermore, when processing the control program, each of the air conditioners 50a, 50b, . . . is identified by its MAC address.

The output unit 33 comprises a display, a speaker, and the like; furthermore, if the control unit 32 detects an abnormal condition in any of the air conditioners 50a, 50b, . . . , then the output unit 33 reports such to staff of the remote management center 3, who are located on the remote management server 30 side.

The input unit 34 comprises a mouse, a keyboard, and the like, and is used by the operator of the remote management server 30 to input operation commands into the remote management server 30.

### <Initialization of the Air Conditioners>

The following text explains the flow of the initialization of the plurality of air conditioners 50a, 50b, . . . belonging to the same user within the same property 2. The initialization of the air conditioners 50a, 50b, . . . consists of a provisional registration, which registers provisional registration data (including the MAC addresses) of the air conditioners 50a, 50b, . . . , and a main registration, which registers the basic information (including the user IDs) of the air conditioners 50a, 50b, . . . such that they are associated with the provisionally registered MAC addresses of the air conditioners 50a, 50b, . . . .

a) Provisional Registration

The provisional registration of the air conditioners 50a, 50b, . . . is a process that is performed automatically by the adapters 20a, 20b, . . . , respectively. More specifically, the adapters 20a, 20b, . . . are programmed such that, when connected to the LAN 5a, they automatically notify the remote management server 30 of their own presence. Furthermore, normally it is the serviceperson who connects the adapters 20a, 20b, . . . to the LAN 5a. When the abovementioned notifications are issued, the relevant MAC addresses are transmitted from the adapters 20a, 20b, . . . to the remote management server 30.

Moreover, the provisional registration unit 32a of the remote management server 30 registers in the provisional registration database 35e the MAC addresses of the adapters 20a, 20b, . . . pertaining to the notifications. Simultaneously, the provisional registration unit 32a registers in the provisional registration database 35e the global IP addresses of the adapters 20a, 20b, . . . such that they are associated with the MAC addresses of the adapters 20a, 20b, . . . , respectively. Furthermore, the global IP address of each of the adapters 20a, 20b, . . . is a combination of the global IP address of the router 40 and the port number corresponding to that adapter. Accordingly, it is possible to identify the LAN 5a to which any of the adapters 20a, 20b, . . . belongs based on the global IP address of that adapter.

Furthermore, the provisional registration unit 32a does not perform provisional registration if the MAC addresses from the adapters 20a, 20b, . . . have already been registered in the provisional registration database 35e or the basic information database 35d.

This completes the provisional registration of the air conditioners 50a, 50b, . . . .

b) Main Registration

The main registration of the air conditioners 50a, 50b, . . . is a process that is performed while the serviceperson manually operates the initialization personal computer 60 or the mobile phone 70. The main registration of the air conditioners 50a, 50b, . . . must be performed after the provisional registration of the air conditioners 50a, 50b, . . . .

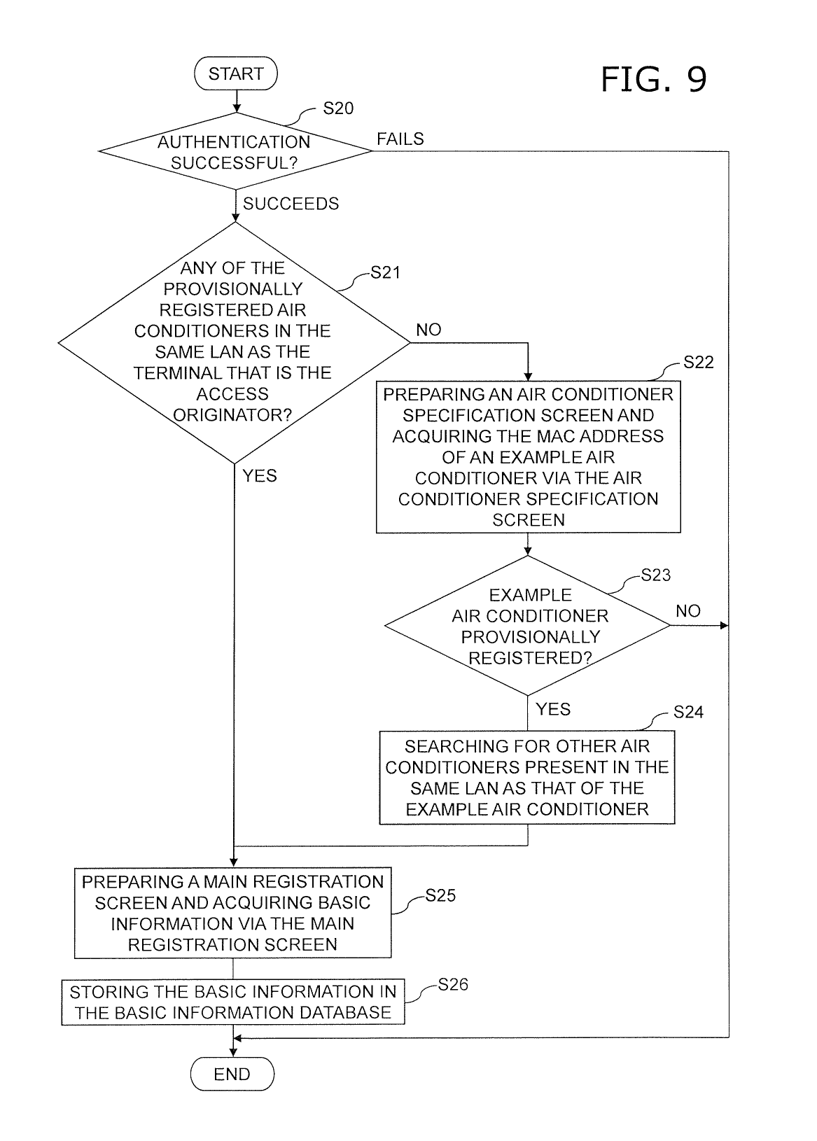

The following text explains the operation of the remote management server 30 during the main registration, referencing FIG. 9, separately for the case wherein the initialization personal computer 60 is used and the case wherein the mobile phone 70 is used.

b-1) Case Wherein the Initialization Personal Computer is Used

First, the serviceperson connects the initialization personal computer 60 to the LAN 5a whereto the air conditioners 50a, 50b, . . . are connected.

Next, the serviceperson accesses the remote management server 30 by launching the Web browser installed on the initialization personal computer 60 and entering a prescribed URL in the Web browser. Upon gaining access, the process of the remote management server 30 shown in FIG. 9 is started.

In a step S20, the authentication unit 32c of the remote management server 30 transmits a login screen to the Web browser of the initialization personal computer 60, which is the access originator. The login screen requests the input of the user ID and the password (hereinbelow, ID and the like) for verifying the login right. The serviceperson must input into the login screen, for example, the ID issued to one of the users of the air conditioners 50a, 50b, . . . about to be registered. The ID and the like input into the login screen are transmitted to the remote management server 30. On the remote management server 30 side, the login right of the serviceperson is authenticated by comparing the ID and the like from the initialization personal computer 60 with the ID and the like stored in the user database 35c. If the authentication succeeds, then the process proceeds to a step S21; if the authentication fails, then the process terminates.

Furthermore, because the authentication process in the step S20 compares the ID and the like inputted with the ID and the like stored in the user database 35c, the registration of the user in the user database 35c must be performed prior to the main registration. Such registration does not have to be performed by the serviceperson while dispatched to the property 2 and rather may be performed by appropriate personnel, such as staff stationed in the remote management center 3, at an appropriate time after a remote management service contract has been concluded with the user.

In the step S21 after the authentication has succeeded, the main registration unit 32b of the remote management server 30 determines whether any of the provisionally registered air conditioners are in the same LAN 5a as the initialization personal computer 60 that is the access originator. More specifically, the main registration unit 32b acquires the global IP address of the given initialization personal computer 60 from that initialization personal computer 60 and, based on that global IP address, identifies the LAN (i.e., the LAN 5a) to which that initialization personal computer 60 belongs. Continuing, the main registration unit 32b, by referencing the global IP addresses in the provisional registration database 35e, searches the provisionally registered air conditioners for those air conditioners 50a, 50b, . . . in the LAN 5a that was identified as the LAN to which the initialization personal computer 60 belongs. If, as a result, one or more of the air conditioners 50a, 50b, . . . is detected, then the process proceeds to a step S25; however, if none of the air conditioners 50a, 50b, . . . are detected, then the process proceeds to a step S22. Accordingly, in the present state wherein the initialization personal computer 60 in the same LAN 5a as that of the provisionally registered air conditioners 50a, 50b, . . . is used in the main registration, the process proceeds to the step S25.

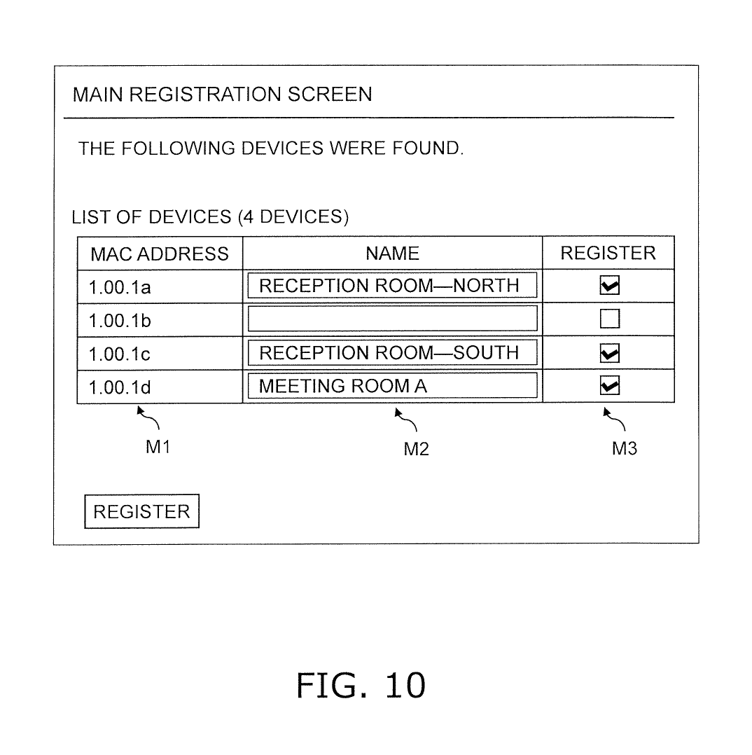

In the step S25, the main registration unit 32b prepares a main registration screen (refer to FIG. 10) and transmits such to the Web browser of the initialization personal computer 60. The main registration screen displays in table format for each of the air conditioners 50a, 50b, . . . detected in the step S21: a display column M1, which displays the MAC address; an input box M2, which is for inputting the device name; and a checkbox M3, which is for selecting whether to perform the main registration.

The serviceperson inputs the device name of each of the air conditioners 50a, 50b, . . . into the input box M2 while verifying the air conditioner 50a, 50b, . . . in the corresponding row based on the MAC address in the display column M1. The serviceperson inputs an appropriate device name into the main registration screen and presses the “registration” button, whereupon the device name is transmitted from the initialization personal computer 60 to the remote management server 30. Furthermore, if none of the air conditioners among the air conditioners 50a, 50b, . . . detected in the step S21 are to be registered, then any of the checkboxes M3 checked by default should be unchecked, after which the “registration” button should be pressed. Any of the air conditioners 50a, 50b, . . . for which the corresponding checkbox M3 was unchecked when the “registration” button was pressed are not subject to registration in the next step, namely, a step S26.

In the step S26, records corresponding to each of the air conditioners 50a, 50b, . . . to be registered are added to the basic information database 35d. More specifically, the main registration unit 32b stores, mutually associated, in the basic information database 35d the MAC address, the device name, and the user ID of each of the air conditioners 50a, 50b, . . . for which the checkbox M3 was checked. The MAC address automatically stored is the one registered in the provisional registration database 35e; the device name automatically stored is the one input into the main registration screen in the step S25; and the user ID automatically stored is the one input during the authentication process in the step S20.

The provisional registration data related to the air conditioners 50a, 50b, . . . , for which the main registration has been completed is deleted from the provisional registration database 35e.

b-2) Case Wherein the Mobile Phone is Used

First, the serviceperson accesses the remote management server 30 by launching the Web browser installed on the mobile phone 70 and entering a prescribed URL in the Web browser. Upon gaining access, the process of the remote management server 30 shown in FIG. 9 is started.

In a step S20, the authentication unit 32c of the remote management server 30 authenticates the mobile phone 70, which is the access originator; furthermore, if the authentication succeeds, then the process proceeds to the step S21. Furthermore, the details of the step S20 are the same as those for the case wherein the initialization personal computer 60 is used.

In the step S21, which is the step after the authentication succeeds, the main registration unit 32b of the remote management server 30 determines whether any of the provisionally registered air conditioners are present in the same LAN 5a as that of the mobile phone 70, which is the access originator. In the present state, wherein the LAN 5a of the mobile phone 70 used in the main registration is different from the LAN 5a of the provisionally registered air conditioners 50a, 50b, . . . , the process proceeds to the step S22. Furthermore, the details of the step S21 are likewise the same as those for the case wherein the initialization personal computer 60 is used.

In the step S22, the main registration unit 32b prepares an air conditioner specification screen, which requests the inputting of information that suggests the air conditioners 50a, 50b, . . . to be registered, and transmits such to the Web browser of the mobile phone 70. The air conditioner specification screen is provided with an entry column for inputting the MAC addresses of the air conditioners 50a, 50b, . . . . If the serviceperson inputs into the entry column the MAC address of any one air conditioner (hereinbelow, called the “example air conditioner”) among the plurality of air conditioners 50a, 50b, . . . to be registered and then presses the “OK” button, then that MAC address is transmitted from the mobile phone 70 to the remote management server 30.

In the next step, namely, a step S23, the main registration unit 32b determines whether the example air conditioner is provisionally registered. More specifically, the main registration unit 32b determines whether the MAC address of the example air conditioner is stored in the provisional registration database 35e. If stored, then the process proceeds to a step S24; if not stored, then the process terminates.

In a step S24, the main registration unit 32b determines whether other provisionally registered air conditioners are present in the same LAN 5a as the LAN 5a of the example air conditioner. More specifically, the main registration unit 32b acquires the global IP address of the example air conditioner from the provisional registration database 35e and identifies the LAN (i.e., the LAN 5a) to which the example air conditioner belongs based on its global IP address. Continuing, the main registration unit 32b, by referencing the global IP addresses in the provisional registration database 35e, searches the provisionally registered air conditioners for other air conditioners present in the LAN 5a that was identified as the LAN 5a to which the example air conditioner belongs. When the search is complete, the process proceeds to the step S25.

In the step S25, the main registration unit 32b prepares the main registration screen (refer to FIG. 10) and transmits such to the Web browser of the mobile phone 70. The details of the step S25 are the same as those for the case wherein the initialization personal computer 60 is used, except that, instead of the MAC addresses of the air conditioners 50a, 50b, . . . detected in the step S21, the MAC addresses of the air conditioners 50a, 50b, ... detected in the steps S23, S24 (i.e., the example air conditioner and, if they exist, other air conditioners in the same LAN 5a as the LAN 5a of the example air conditioner) are displayed in the display column M1.

Accordingly, the serviceperson inputs the device name of each of the air conditioners 50a, 50b, . . . into the input box M2 while verifying the air conditioner 50a, 50b, . . . in the corresponding row based on the MAC address in the display column M1. The serviceperson inputs an appropriate device name into the main registration screen and presses the “registration” button, whereupon the device name is transmitted from the mobile phone 70 to the remote management server 30. Furthermore, if there are the air conditioners that should not be registered among the air conditioners 50a, 50b, . . . detected in the step S24, then the corresponding checkboxes M3 checked by default should be unchecked, after which the “registration” button should be pressed. Any of the air conditioners 50a, 50b, . . . for which the corresponding checkbox M3 was unchecked when the “registration” button was pressed are not subject to registration in the next step, namely, the step S26.

The details of the step S26 are the same as those for the case wherein the initialization personal computer 60 is used.

### <Characteristics>

(1)

In the abovementioned remote management server 30, the MAC addresses and the global IP addresses of the air conditioners 50a, 50b, . . . are provisionally registered automatically prior to the main registration, which mutually associates the MAC addresses and the basic information (including the user IDs) of the air conditioners 50a, 50b, . . . . As a result, if the serviceperson performs the procedure during the main registration within the same LAN 5a as that of the air conditioners 50a, 50b, . . . to be registered, then the serviceperson no longer has to manually input the MAC addresses in order to identify the air conditioners 50a, 50b, . . . to be registered. This is because the global IP address of the device of the access originator (in the abovementioned embodiment, the initialization personal computer 60) suggests the air conditioners 50a, 50b, . . . to be registered.

In addition, during the main registration, if the serviceperson accesses the remote management server 30 from within the LAN 5a that is different from that of the air conditioners 50a, 50b, . . . to be registered, then the plurality of the air conditioners 50a, 50b, . . . can be registered merely by inputting a single MAC address. This is because the other air conditioners in the same LAN 5a as that of the relevant air conditioner can be identified from the global IP address of the air conditioner (i.e., the example air conditioner) corresponding to the inputted MAC address.

Accordingly, the burden on the serviceperson during the initialization is lightened.

(2)

In the abovementioned remote management server 30, the user ID and the like for logging into the remote management server 30 are automatically registered in the main registration as part of the basic information. Accordingly, the burden on the serviceperson is lightened.

(3)

In the abovementioned embodiment, the provisional registration and the main registration are independent processes. Accordingly, there is no need to freeze the processing of the remote management server 30 during the interval from the end of the provisional registration to the beginning of the main registration, which increases the flexibility of the process.

(4)

In the abovementioned embodiment, no special program whatsoever is installed in the initialization personal computer 60 and the mobile phone 70 for initializing the air conditioners 50a, 50b, . . . , and any needed screens and the like are downloaded from the remote management server 30.

### <Modified Examples>

### (A)

In the abovementioned embodiment, the facility devices to be managed by the remote management system 1 do not have to be air conditioners and may be, for example, other types of facility devices such as lighting equipment, hot water supply equipment, and locking equipment.

### (B)

In the abovementioned embodiment, the function of each of the adapters 20a, 20b, . . . may instead be provided to the control unit 11 of the respective air conditioner main bodies 10a, 10b, . . . . In such a case, the adapters 20a, 20b, . . . would not be needed.

### (C)

In the abovementioned embodiment, the remote management server 30 specifies the air conditioners 50a, 50b, . . . to be registered based on the global IP addresses or the MAC addresses acquired during the main registration from the terminal (i.e., the initialization personal computer 60 or the mobile phone 70) that is the access originator. Nevertheless, the information (i.e., the suggesting information) for specifying the air conditioners 50a, 50b, . . . to be registered is not limited to that discussed above.

For example, if a keyword setting function is added to the adapters 20a, 20b, . . . or the air conditioner main bodies 10a, 10b, . . . , then the serviceperson can set appropriate keywords in the adapters 20a, 20b, . . . or the air conditioner main bodies 10a, 10b, . . . in advance. Then, during the provisional registration, the keywords are reported to the remote management server 30 together with the MAC addresses of the air conditioners 50a, 50b, . . . , and are registered. Continuing, during the main registration, the step S22 requests that keywords be input instead of the MAC addresses. The remote management server 30 can specify the air conditioners 50a, 50b, . . . to be registered (i.e., the air conditioners wherein the keyword is set and other air conditioners present in the same LAN 5a as the LAN 5a of that air conditioner) from among the provisionally registered air conditioners 50a, 50b, . . . by comparing the inputted keyword with the provisionally registered keywords.

Alternatively, the information for specifying the air conditioners 50a, 50b, . . . to be registered (i.e., the suggesting information) may be the global IP addresses of the air conditioners 50a, 50b, . . . . In such a case, for example, during the main registration, the step S22 requests that the global IP addresses of the air conditioners 50a, 50b, . . . be input instead of the MAC addresses. The remote management server 30 could specify the air conditioners 50a, 50b, . . . to be registered from among the provisionally registered air conditioners 50a, 50b, . . . by comparing the inputted global IP address with the provisionally registered global IP addresses.

### (D)

In the above embodiment, the serviceperson who performs the main registration must log into the remote management server 30 using the user ID to be registered (i.e., in the step S20). Nevertheless, a configuration may be adopted wherein the serviceperson logs in using a user ID other than the user ID to be registered, after which the serviceperson is additionally asked, via the initialization personal computer 60 or the mobile phone 70, to input user IDs registered as part of the basic information.

### (E)

The above embodiment explained a case wherein initialization is performed using the initialization personal computer 60 or the mobile phone 70; however, initialization can be performed by a device other than these devices 60 and 70. Namely, as a rule, any device can be used in the initialization as long as it is capable of connecting to the Internet 6.

### (F)

The above embodiment explained a case wherein the main registration is performed by the serviceperson while he or she is assigned onsite; however, in light of the spirit of the present invention wherein main registration can also be performed outside of the LAN 5a, it is obvious that main registration can also be performed from a location other than onsite.

### (G)

The basic information subject to the main registration is not limited to the information discussed above. For example, the connection configuration and device numbers of the outdoor units and the indoor units incorporated in the air conditioner main bodies 10a, 10b, . . . , the network setting information of the adapters 20a, 20b, . . . , and the like may constitute the basic information subject to main registration.

In such a case, such information is preferably reported automatically by the adapters 20a, 20b. . . . to the remote management server 30 during the provisional registration and referenced automatically during the main registration.

### (H)

In the above embodiment, the provisional registration is automatically started when the adapters 20a, 20b, . . . are connected to the LAN 5a. Nevertheless, the provisional registration may be automatically started, for example, when the power supply of any of the adapters 20a, 20b, . . . is turned on or when the serviceperson presses an auxiliary switch on any of the adapters 20a, 20b, . . . .

### (I)

Information other than the MAC addresses may be used as the information for identifying the air conditioners 50a, 50b, . . . .

### INDUSTRIAL APPLICABILITY

An effect of the present invention is that it makes it easy to perform the operation of registering facility devices and their users in a remote management apparatus such that they are associated with one another; moreover, the present invention is useful as a remote management apparatus that remotely manages the facility devices and as a remote management system that comprises the same.

### REFERENCE SIGNS LIST

1 Remote management system

2 Property

3 Remote management center

5a LAN

6 Internet

10a, 10b, . . . Air conditioner main bodies

20a, 20b, . . . Adapters

22 Control unit (notification unit)

30 Remote management server (remote management apparatus)

32 Control unit

32a Provisional registration unit

32b Main registration unit

32c Authentication unit

35 Storage unit

50a, 50b, . . . Air conditioners (facility devices)

60 Initialization personal computer (registration terminal)

70 Mobile phone (registration terminal)

### Citation List

### Patent Literature

### Patent Document 1

Japanese Unexamined Patent Application Publication No. 2005-301982

1. A remote management apparatus configured to remotely manage at least one facility device, the remote management apparatus comprising:
a provisional registration unit configured to register a device identifier, which is transmitted from and identifies the facility device; and
a main registration unit configured to register user information, which is transmitted from a registration terminal and is related to a user of the facility device, such that the user information is associated with the device identifier.

2. The remote management apparatus according to claim 1, wherein
the main registration unit is further configured to reference suggesting information, which is further transmitted from the registration terminal and suggests the facility device, to associate the user information with the device identifier.

3. The remote management apparatus according to claim 2, wherein
the suggesting information is terminal LAN information, which identifies a LAN where the registration terminal is present;
the provisional registration unit is further configured to register device LAN information, which identifies a LAN where the facility device is present, such that the device LAN information is associated with the device identifier; and
the main registration unit is further configured to further reference the device LAN information to associate the user information with the device identifier.

4. The remote management apparatus according to claim 2, wherein
the main registration unit is further configured to request an operator of the registration terminal to input the suggesting information via the registration terminal.

5. The remote management apparatus according to claim 4, wherein
the suggesting information is the device identifier.

6. The remote management apparatus according to claim 4, wherein
the suggesting information is a keyword, which is set for the facility device; and
the provisional registration unit is further configured to register the keyword, which is further transmitted from the facility device, such that the keyword is associated with the device identifier.

7. The remote management apparatus according to claim 1, further comprising
an authentication unit configured to authenticate the registration terminal, the authentication unit being configured to request the user information from the registration terminal in order to perform the authentication of the registration terminal, and
the main registration unit being further is configured to associate the user information acquired by the authentication unit with the device identifier.

8. A remote management system, comprising:
at least one facility device;
a remote management apparatus configured to remotely manage the facility device; and
a registration terminal configured to be connected to the remote management apparatus when the facility device is being registered in the remote management apparatus,
the facility device including
a notification unit configured to report a device identifier that identifies the facility device to the remote management apparatus, and
the remote management apparatus including
a provisional registration unit configured to register the device identifier reported from the notification unit, and
a main registration unit configured to register user information, which is transmitted from the registration terminal and is related to a user of the facility device, such that the user information is associated with the device identifier.

9. The remote management system according to claim 8, wherein
the main registration unit is further configured to reference suggesting information, which is further transmitted from the registration terminal and suggests the facility device, to associate the user information with the device identifier.

10. The remote management system according to claim 8, wherein
the notification unit is further configured to automatically report the device identifier to the remote management apparatus when the power supply to the facility device is turned on or when the facility device is connected to a LAN.

11. The remote management system according to claim 9, wherein
the notification unit is further configured to automatically report the device identifier to the remote management apparatus when the power supply to the facility device is turned on or when the facility device is connected to a LAN.

12. The remote management apparatus according to claim 2, further comprising
an authentication unit configured to authenticate the registration terminal, the authentication unit being configured to request the user information from the registration terminal in order to perform the authentication of the registration terminal, and
the main registration unit being further configured to associate the user information acquired by the authentication unit with the device identifier.

13. The remote management apparatus according to claim 3, further comprising
an authentication unit configured to authenticate the registration terminal, the authentication unit being configured to request the user information from the registration terminal in order to perform the authentication of the registration terminal, and
the main registration unit being further configured to associate the user information acquired by the authentication unit with the device identifier.

14. The remote management apparatus according to claim 4, further comprising
an authentication unit configured to authenticate the registration terminal, the authentication unit being configured to request the user information from the registration terminal in order to perform the authentication of the registration terminal, and
the main registration unit being further configured to associate the user information acquired by the authentication unit with the device identifier.

15. The remote management apparatus according to claim 5, further comprising
an authentication unit configured to authenticate the registration terminal, the authentication unit being configured to request the user information from the registration terminal in order to perform the authentication of the registration terminal, and
the main registration unit being further configured to associate the user information acquired by the authentication unit with the device identifier.

16. The remote management apparatus according to claim 6, further comprising
an authentication unit configured to authenticate the registration terminal, the authentication unit being configured to request the user information from the registration terminal in order to perform the authentication of the registration terminal, and
the main registration unit being further configured to associate the user information acquired by the authentication unit with the device identifier.
